(19) United States
(12) Patent Application Publication
(10) Pub. No.: US 2024/0154769 A1
(43) Pub. Date: May 9, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/385,916

(22) Filed: Nov. 1, 2023

(30) Foreign Application Priority Data
Nov. 3, 2022 (CN) 202211368268.1

(51) Int. Cl. H04L 5/00; H04W 72/232

(52) U.S. Cl. CPC H04L 5/0055; H04W 72/232

(57) ABSTRACT

The present application provides a method and device in a node for wireless communications. A first receiver monitors a PDCCH at least associated with a target serving cell in a target monitoring occasion, the target serving cell is a configured serving cell; a first transmitter transmits a target HARQ-ACK bit block; wherein a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

### CROSS REFERENCE TO RELATED APPLICATIONS

This application claims the priority benefit of Chinese Patent Application No. 202211368268.1, filed on Nov. 3, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

Network energy saving is crucial for environmental sustainability, reducing environmental impacts, and saving operating costs. With the denser layout of radio networks, the use of more antennas, larger bandwidth, and more frequency-bands, as well as the continuous improvement of transmission data rate, the enhancement of network energy saving has become an important aspect of 5G and future network development; how to handle Hybrid automatic repeat request acknowledgement (HARQ-ACK) feedback after network energy-saving enhancement is a necessary research topic.

### SUMMARY

To address the above problem, the present application provides a solution. It should be noted that the above description uses scenarios related to network energy-saving enhancement as examples; the present application is also applicable to other scenarios, such as non-network energy-saving enhancement scenarios, Enhanced Mobile Broadband (eMBB), Ultra Reliable and Low Latency Communication (URLLC), Multicast Broadcast Services (NIBS), Internet of Things (IoT), the Internet of Vehicles, non-terrestrial networks (NTN), shared spectrum and etc., where similar technical effects can be achieved. In addition, adopting a unified solution for different scenarios (including but not limited to scenarios related to network energy-saving enhancement, scenarios related to non-network energy-saving enhancement, eMBB, URLLC, MBS, IoT, Internet of Vehicles, NTN, and shared spectrum) can also help reduce hardware complexity and cost, or improve performance. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
monitoring a PDCCH at least associated with a target serving cell in a target monitoring occasion, the target serving cell being a configured serving cell; and
transmitting a target HARQ-ACK bit block;
herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one embodiment, advantages of the above method comprise: improving efficiency of HARQ-ACK feedback.

In one embodiment, advantages of the above method comprise: reducing the overhead of HARQ-ACK feedback.

In one embodiment, advantages of the above method comprise: simplifying the system design and reducing the complexity of network testing.

In one embodiment, advantages of the above method comprise: reducing energy consumption of the base station and the terminal.

In one embodiment, advantages of the above method comprise: saving operating costs.

In one embodiment, advantages of the above method comprise: improving resource utilization.

In one embodiment, advantages of the above method comprise: good compatibility.

In one embodiment, advantages of the above method comprise: causing minor changes to the existing 3GPP standard.

According to one aspect of the present application, the above method is characterized in that
in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

According to one aspect of the present application, the above method is characterized in that
a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell.

According to one aspect of the present application, the above method is characterized in that
a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

According to one aspect of the present application, the above method is characterized in that
if at least one HARQ-ACK bit corresponding to the target serving cell is generated for the target monitoring occasion in the process of determining the target HARQ-ACK bit block, the target HARQ-ACK bit block comprises the at least one HARQ-ACK bit corresponding to the target serving cell for the target monitoring occasion.

According to one aspect of the present application, the above method is characterized in that
an Information Element (IE) BWP-Downlink used to configure the same active BWP comprises a first parameter set, within the same active BWP, each parameter in the first parameter set is adopted both before and after the first-type configuration change occurs.

In one embodiment, advantages of the above method comprise: effectively reducing the delay when configuration change occurs, thus improving the system efficiency.

In one embodiment, advantages of the above method comprise: reducing the overhead of a control signaling.

According to one aspect of the present application, the above method is characterized in that
an IE BWP-Uplink used to configure the same active BWP comprises a first parameter set, within the same active BWP, each parameter in the first parameter set is adopted both before and after the first-type configuration change occurs.

In one embodiment, advantages of the above method comprise: effectively reducing the delay when configuration change occurs, thus improving the system efficiency.

In one embodiment, advantages of the above method comprise: reducing the overhead of a control signaling

According to one aspect of the present application, the above method is characterized in that
multiple frequency-band resources are configured for the same active BWP, and the first-type configuration change comprises switching among the multiple frequency-band resources within the same active BWP.

The present application provides a method in a second node for wireless communications, comprising:
transmitting a PDCCH associated with a target serving cell in a target monitoring occasion, the target serving cell being a configured serving cell; and
receiving a target HARQ-ACK bit block;
herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

According to one aspect of the present application, the above method is characterized in that
in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

According to one aspect of the present application, the above method is characterized in that
a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell.

According to one aspect of the present application, the above method is characterized in that
a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

According to one aspect of the present application, the above method is characterized in that
if at least one HARQ-ACK bit corresponding to the target serving cell is generated for the target monitoring occasion in the process of determining the target HARQ-ACK bit block, the target HARQ-ACK bit block comprises the at least one HARQ-ACK bit corresponding to the target serving cell for the target monitoring occasion.

According to one aspect of the present application, the above method is characterized in that
an IE BWP-Downlink used to configure the same active BWP comprises a first parameter set, within the same active BWP, each parameter in the first parameter set is adopted both before and after the first-type configuration change occurs.

According to one aspect of the present application, the above method is characterized in that
an IE BWP-Uplink used to configure the same active BWP comprises a first parameter set, within the same active BWP, each parameter in the first parameter set is adopted both before and after the first-type configuration change occurs.

According to one aspect of the present application, the above method is characterized in that
multiple frequency-band resources are configured for the same active BWP, and the first-type configuration change comprises switching among the multiple frequency-band resources within the same active BWP.

The present application provides a first node for wireless communications, comprising:
a first receiver, monitoring a PDCCH at least associated with a target serving cell in a target monitoring occasion, the target serving cell being a configured serving cell; and
a first transmitter, transmitting a target HARQ-ACK bit block;
herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

The present application provides a second node for wireless communications, comprising:
a second transmitter, transmitting a PDCCH associated with a target serving cell in a target monitoring occasion, the target serving cell being a configured serving cell;
a second receiver, receiving a target HARQ-ACK bit block;
herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of signal transmission according to one embodiment of the present application;

FIG. 6 illustrates a schematic diagram of relations among a target HARQ-ACK bit block, a target monitoring occasion, a first condition set as well as a target serving cell according to one embodiment of the present application;

FIG. 7 illustrates a schematic diagram of a first condition set according to one embodiment of the present application;

FIG. 8 illustrates a schematic diagram of relations among a target HARQ-ACK bit block, a target monitoring occasion, a first condition set, a second condition set as well as a target serving cell according to one embodiment of the present application;

FIG. 9 illustrates a schematic diagram of a second condition set according to one embodiment of the present application;

FIG. 10 illustrates a schematic diagram of relations among a first-type configuration change, a same active BWP as well as a first parameter set according to one embodiment of the present application;

FIG. 11 illustrates a schematic diagram of relations among a first-type configuration change, a same active BWP as well as a first parameter set according to one embodiment of the present application;

FIG. 12 illustrates a schematic diagram of relations among a first-type configuration change, a same active BWP as well as multiple frequency-band resources according to one embodiment of the present application;

FIG. 13 illustrates a structure block diagram of a processor in a first node according to one embodiment of the present application;

FIG. 14 illustrates a structure block diagram of a processor in second node according to one embodiment of the present application.

### DESCRIPTION OF THE EMBODIMENTS

The technical solution of the present application will be further described in detail below in combination with the drawings. It should be noted that, in the case of no conflict, the embodiments of the present application and the features in the embodiments may be combined with each other arbitrarily.

### Embodiment 1

Embodiment 1 illustrates a flowchart of processing of a first node according to one embodiment of the present application, as shown in FIG. 1.

In Embodiment 1, the first node in the present application monitors a PDCCH at least associated with a target serving cell in a target monitoring occasion in step 101; transmits a target HARQ-ACK bit block in step 102.

In embodiment 1, the target serving cell is a configured serving cell; a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one embodiment, the target monitoring occasion is a PDCCH monitoring occasion.

In one embodiment, the target monitoring occasion is configured for monitoring a PDCCH.

In one embodiment, a first monitoring occasion set is configured to monitor a PDCCH.

In one embodiment, a first monitoring occasion set is configured to monitor a Downlink Control Information (DCI) format.

In one embodiment, a first monitoring occasion set is for a DCI format used to schedule a PDSCH reception or with associated Hybrid automatic repeat request acknowledgement (HARQ-ACK) information, and the first monitoring occasion set is defined as a union of PDCCH monitoring occasions on an active DL BWP of a configured serving cell.

In one embodiment, the first monitoring occasion set comprises at least one monitoring occasion.

In one embodiment, the first monitoring occasion set comprises at least one PDCCH monitoring occasion.

In one embodiment, the first monitoring occasion set is configurable.

In one embodiment, the target monitoring occasion is one occasion in the first monitoring occasion set.

In one embodiment, the target monitoring occasion is any occasion in the first monitoring occasion set.

In one embodiment, the target monitoring occasion comprises at least one symbol in time domain.

In one embodiment, the target monitoring occasion comprises at least one multicarrier symbol in time domain.

In one embodiment, the multicarrier symbol in the present application is an Orthogonal Frequency Division Multiplexing (OFDM) symbol.

In one embodiment, the multicarrier symbol in the present application is a Single Carrier-Frequency Division Multiple Access (SC-FDMA) symbol.

In one embodiment, the multicarrier symbol in the present application is a Discrete Fourier Transform Spread OFDM (DFT-S-OFDM) symbol.

In one embodiment, the multicarrier symbol in the present application is a Filter Bank Multicarrier (FBMC) symbol.

In one embodiment, the multicarrier symbol in the present application comprises a Cyclic Prefix (CP).

In one embodiment, if at least one PDCCH is scheduled by a DCI format received in a PDCCH, then the PDCCH is a PDCCH associated with the at least one PDCCH.

In one embodiment, the target monitoring occasion is specific to a slot where a PUCCH occupied by a transmission of the target HARQ-ACK bit block is located.

In one embodiment, the first monitoring occasion set is specific to a slot where a PUCCH occupied by a transmission of the target HARQ-ACK bit block is located.

In one embodiment, the expression of “transmitting a PDCCH associated with a target serving cell in a target monitoring occasion” and the expression of “transmitting a PDCCH associated with a first PDSCH in a target monitoring occasion, and the first PDSCH being a PDSCH on a target serving cell” are equivalent or interchangeable.

In one embodiment, the expression of “monitoring a PDCCH at least associated with a target serving cell in a target monitoring occasion” and the expression of “receiving a PDCCH associated with a first PDSCH in a target monitoring occasion, and the first PDSCH being a PDSCH on a target serving cell” are equivalent or interchangeable.

In one embodiment, the expression of “transmitting a PDCCH associated with a target serving cell in a target monitoring occasion” comprises: transmitting a PDCCH associated with a first PDSCH in a target monitoring occasion, and the first PDSCH being a PDSCH on a target serving cell.

In one embodiment, the expression of “monitoring a PDCCH associated with a target serving cell in a target monitoring occasion” comprises: receiving a PDCCH associated with a first PDSCH in a target monitoring occasion, and the first PDSCH being a PDSCH on a target serving cell.

In one embodiment, the expression of “monitoring a PDCCH associated with a target serving cell in a target monitoring occasion” comprises: receiving a PDCCH associated with a target serving cell in a target monitoring occasion.

In one embodiment, the expression of “monitoring a PDCCH at least associated with a target serving cell in a target monitoring occasion” and the expression of “receiving a PDCCH associated with a target serving cell in a target monitoring occasion” are equivalent or interchangeable.

In one embodiment, for the first node, a reception of the first PDSCH depends on the PDCCH associated with the first PDSCH.

In one embodiment, the PDCCH associated with the first PDSCH is a PDCCH indicating a reception of the first PDSCH.

In one embodiment, the expression of receiving a PDCCH associated with a first PDSCH in a target monitoring occasion comprises: receiving a DCI format in a PDCCH in a target monitoring occasion, and the DCI format scheduling a first PDSCH.

In one embodiment, the expression of receiving a PDCCH associated with a first PDSCH in a target monitoring occasion refers to: receiving a DCI format in a PDCCH in a target monitoring occasion, and the DCI format scheduling a first PDSCH.

In one embodiment, frequency-domain resources occupied by the first PDSCH belong to the target serving cell.

In one embodiment, the first PDSCH is received on the target serving cell.

In one embodiment, at least one IE for the target serving cell comprises at least part of configuration adopted by the first PDSCH.

In one embodiment, the target serving cell is configured by an RRC signaling.

In one embodiment, the target serving cell is a Primary cell.

In one embodiment, the target serving cell is a Secondary cell.

In one embodiment, the target serving cell is a Primary secondary cell.

In one embodiment, only when the target monitoring occasion is not before the reference change occasion, the first node receives the PDCCH associated with the first PDSCH in the target monitoring occasion.

In one embodiment, regardless of whether the target monitoring occasion is before the reference change occasion, the first node receives the PDCCH associated with the first PDSCH in the target monitoring occasion.

In one embodiment, receiving the PDCCH associated with the first PDSCH comprises the following meaning: receiving a DCI format for scheduling the first PDSCH in the PDCCH.

In one embodiment, receiving the PDCCH associated with the first PDSCH comprises the following meaning: receiving a control signaling in the PDCCH associated with the first PDSCH.

In one embodiment, receiving the PDCCH associated with the first PDSCH comprises the following meaning: receiving the PDCCH, and the PDCCH comprising scheduling information for the first PDSCH.

In one embodiment, receiving the PDCCH associated with the first PDSCH comprises the following meaning: detecting the PDCCH associated with the first PDSCH.

In one embodiment, receiving the PDCCH associated with the first PDSCH in the target monitoring occasion comprises the following meaning: detecting a DCI format for scheduling the first PDSCH in the PDCCH in the target monitoring occasion.

In one embodiment, a PDCCH associated with the target serving cell is: a PDCCH bearing a DCI format scheduling a PDSCH reception on an active DL BWP of the target serving cell or a DCI format with associated HARQ-ACK information while not scheduling a PDSCH reception.

In one embodiment, a PDCCH associated with the target serving cell is: a PDCCH on an active downlink BWP of the target serving cell.

In one embodiment, a PDCCH associated with the target serving cell is: for a PDCCH of the target serving cell.

In one embodiment, a PDCCH associated with the target serving cell is: a PDCCH bearing a DCI format for the target serving cell.

In one embodiment, a PDCCH associated with the target serving cell is: a PDCCH bearing a DCI format associated with the target serving cell.

In one embodiment, the first node receives a PDCCH associated with the target serving cell in the target monitoring occasion.

In one embodiment, a transmission of the target HARQ-ACK bit block is not before the reference change occasion.

In one embodiment, the expression of transmitting a target HARQ-ACK bit block comprises: transmitting a target HARQ-ACK bit block in a Physical uplink control channel (PUCCH).

In one embodiment, the expression of transmitting a target HARQ-ACK bit block comprises: transmitting a target HARQ-ACK bit block in a PUSCH.

In one embodiment, the target HARQ-ACK bit block is transmitted in a PUCCH.

In one embodiment, the target HARQ-ACK bit block is transmitted in a PUSCH.

In one embodiment, the target HARQ-ACK bit block is transmitted after through at least information coding.

In one embodiment, the target HARQ-ACK bit block is transmitted after through at least channel coding, scrambling, modulation, and mapping to physical resources.

In one embodiment, the target HARQ-ACK bit block is transmitted after through at least sequence generation and mapping to physical resources.

In one embodiment, the target HARQ-ACK bit block is transmitted after through at least sequence modulation and mapping to physical resources.

In one embodiment, the target HARQ-ACK bit block comprises at least one HARQ-ACK bit.

In one embodiment, the target HARQ-ACK bit block comprises a HARQ-ACK codebook.

In one embodiment, the target HARQ-ACK bit block comprises a Type-2 HARQ-ACK codebook.

In one embodiment, the target HARQ-ACK bit block is a HARQ-ACK codebook.

In one embodiment, the target HARQ-ACK bit block is a Type-2 HARQ-ACK codebook.

In one embodiment, the reference change occasion is a slot.

In one embodiment, the reference change occasion comprises at least one slot.

In one embodiment, the reference change occasion comprises at least one symbol.

In one embodiment, the expression of a reference change occasion comprising time occupied by the first-type configuration change comprises: the reference change occasion comprises at least one slot occupied by the first-type configuration change.

In one embodiment, the expression of a reference change occasion comprising time occupied by the first-type configuration change comprises: the reference change occasion comprises at least one symbol occupied by the first-type configuration change.

In one embodiment, the expression of a reference change occasion comprising time occupied by the first-type configuration change comprises: the reference change occasion comprises a duration occupied by the first-type configuration change.

In one embodiment, the expression of a reference change occasion comprising time occupied by the first-type configuration change comprises: the reference change occasion comprises a start time of the first-type configuration change.

In one embodiment, the expression of a reference change occasion comprising time occupied by the first-type configuration change comprises: the reference change occasion comprises an end time of the first-type configuration change.

In one embodiment, the reference change occasion comprises a duration occupied by the first-type configuration change.

In one embodiment, the reference change occasion comprises a duration occupied by the first-type configuration change from start to end.

In one embodiment, the reference change occasion is a continuous duration.

In one embodiment, the reference change occasion is time occupied by the first-type configuration change.

In one embodiment, the reference change occasion is a slot occupied by the first-type configuration change.

In one embodiment, the reference change occasion is a start time of the first-type configuration change.

In one embodiment, the reference change occasion is an end time of the first-type configuration change.

In one embodiment, the first-type configuration change occurs in the reference change occasion.

In one embodiment, the first-type configuration change starts in the reference change occasion.

In one embodiment, the first-type configuration change ends in the reference change occasion.

In one embodiment, the expression of the first-type configuration change occurring in a same active BWP comprises: the first-type configuration change does not trigger a BWP change.

In one embodiment, the expression of the first-type configuration change occurring in a same active BWP comprises: the first-type configuration change does not comprise a BWP change.

In one embodiment, the expression of the first-type configuration change occurring in a same active BWP comprises: the first-type configuration change does not involve a BWP change.

In one embodiment, the expression of the first-type configuration change occurring in a same active BWP comprises: active frequency-domain resources before and after the first-type configuration change occurs belong to the same active BWP.

In one embodiment, the expression of the first-type configuration change occurring in a same active BWP comprises: all changes comprised in the first-type configuration change are changes among parameters configured within the same active Bandwidth part (BWP).

In one embodiment, the first-type configuration change comprises changes for a configuration of a Physical Downlink Shared Channel (PDSCH).

In one embodiment, the first-type configuration change comprises changes for a configuration of a Physical downlink control channel (PDCCH).

In one embodiment, the first-type configuration change comprises changes for a configuration of DL Semi-persistent scheduling (SPS).

In one embodiment, the first-type configuration change comprises changes for a configuration of a PUCCH.

In one embodiment, the first-type configuration change comprises changes for a configuration of a Physical uplink shared channel (PUSCH).

In one embodiment, the first-type configuration change comprises changes for a configurations of Configured Grant.

In one embodiment, the first-type configuration change comprises switching between two pdcch-Configs.

In one embodiment, the first-type configuration change comprises switching between two pdsch-Configs.

In one embodiment, the first-type configuration change comprises switching between two pucch-Configs.

In one embodiment, the first-type configuration change comprises switching between two pusch-Configs.

In one embodiment, the first-type configuration change comprises switching between two configuration sets for DL SPS.

In one embodiment, the first-type configuration change comprises switching between two configuration sets for configured grant.

In one embodiment, the first-type configuration change comprises switching between two configuration sets for a PDSCH.

In one embodiment, the first-type configuration change comprises switching between two configuration sets for a PDCCH.

In one embodiment, the first-type configuration change comprises switching between two configuration sets for a PUCCH.

In one embodiment, the first-type configuration change comprises switching between two configuration sets for a PUSCH.

In one embodiment, the frequency-band resources comprise at least one of frequency-domain location and bandwidth.

In one embodiment, the frequency-band resources only comprise frequency-domain location and bandwidth.

In one embodiment, the first-type configuration change comprises switching of frequency-domain locations.

In one embodiment, the first-type configuration change comprises switching of bandwidth.

In one embodiment, the expression of the first-type configuration change comprising changes in frequency-band resources comprises: the first-type configuration change comprises switching among sets of resource blocks.

In one embodiment, the expression of the first-type configuration change comprising changes in frequency-band resources comprises: the first-type configuration change comprises switching among sets of physical resource blocks.

In one embodiment, the change of the bandwidth resources comprises: change in a number of Resource Blocks (RBs).

In one embodiment, the change of the bandwidth resources comprises: change in a number of physical resource blocks (PRBs).

In one embodiment, the change of the bandwidth resources comprises: change in a number of active resource block(s).

In one embodiment, the change of the bandwidth resources comprises: change in a number of active physical resource block(s).

In one embodiment, the change of the bandwidth resources is: change in a number of resource block(s).

In one embodiment, the change of the bandwidth resources is: change in a number of physical resource block(s).

In one embodiment, the change of the bandwidth resources is: switching among sets of resource blocks.

In one embodiment, the change of the bandwidth resources is: switching among physical sets of resource blocks.

In one embodiment, the change of the bandwidth resources is: change in at least one of frequency-domain location and bandwidth.

In one embodiment, the change of the bandwidth resources comprises: change in a number of resource blocks used to transmit one or more of PBCH, SS, SSB, PDSCH, PDCCH, PUSCH, PUCCH, RS or PRACH.

In one embodiment, the change of the bandwidth resources comprises: change in a number of physical resource block(s) used to transmit one or more of Physical broadcast channel (PBCH), synchronization signal (SS), SS/PBCH block (SSB), PDSCH, PDCCH, PUSCH, PUCCH, Reference signal (RS), and Physical random access channel (PRACH).

In one embodiment, whether the target HARQ-ACK bit block comprises a HARQ-ACK bit for the target serving cell depends on a sequence between the target monitoring occasion and the reference change occasion.

In one embodiment, whether the target HARQ-ACK bit block comprises a HARQ-ACK bit for a Transport Block (TB) in the first PDSCH depends on a sequence between the target monitoring occasion and the reference change occasion.

In one embodiment, a sequence between the target monitoring occasion and the reference change occasion is used to indicate a HARQ-ACK bit comprised in the target HARQ-ACK bit block.

In one embodiment, a sequence between the target monitoring occasion and the reference change occasion is used to indicate a size of the target HARQ-ACK bit block.

In one embodiment, the expression of the target HARQ-ACK bit block depending on a sequence between the target monitoring occasion and the reference change occasion comprises:

in the process of determining the target HARQ-ACK bit block: in a loop for the target monitoring occasion and the target serving cell, whether there exists an operation to generate at least one HARQ-ACK bit depends on a sequence between the target monitoring occasion and the reference change occasion.

In one embodiment, the expression of the target HARQ-ACK bit block depending on a sequence between the target monitoring occasion and the reference change occasion comprises: a determination of the target HARQ-ACK bit block depends on a sequence between the target monitoring occasion and the reference change occasion.

In one embodiment, the expression of the target HARQ-ACK bit block depending on a sequence between the target monitoring occasion and the reference change occasion comprises:
in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

In one embodiment, the expression of the target HARQ-ACK bit block depending on a sequence between the target monitoring occasion and the reference change occasion comprises:
a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell.

In one embodiment, the expression of the target HARQ-ACK bit block depending on a sequence between the target monitoring occasion and the reference change occasion comprises:
a first condition set comprises that the target monitoring occasion is before the reference change occasion; in the process of determining the target HARQ-ACK bit block: for the target monitoring occasion: if each condition in the first condition set is satisfied, skipping a generation of HARQ-ACK bit(s) corresponding to the target serving cell, otherwise generating at least one HARQ-ACK bit corresponding to the target serving cell.

In one embodiment, the expression of the target HARQ-ACK bit block depending on a sequence between the target monitoring occasion and the reference change occasion comprises:
a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

In one embodiment, the expression of the target HARQ-ACK bit block depending on a sequence between the target monitoring occasion and the reference change occasion comprises:
a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell.

In one embodiment, the expression of “the target HARQ-ACK bit block depending on a sequence between the target monitoring occasion and the reference change occasion” and the expression of “in the process of determining the target HARQ-ACK bit block: in a loop for the target monitoring occasion and the target serving cell, whether there exists an operation to generate at least one HARQ-ACK bit depends on a sequence between the target monitoring occasion and the reference change occasion” is equivalent or can be replaceable.

In one embodiment, the expression of “the target HARQ-ACK bit block depending on a sequence between the target monitoring occasion and the reference change occasion” and the expression of “a determination of the target HARQ-ACK bit block depending on a sequence of the target monitoring occasion and the reference change occasion” are equivalent or interchangeable.

In one embodiment, the expression of “the target HARQ-ACK bit block depending on a sequence between the target monitoring occasion and the reference change occasion” and the expression of “in the process of determining the target HARQ-ACK bit block: for the target monitoring occasion, whether to skip a generation of HARQ-ACK bit(s) corresponding to the target serving cell depends on the sequence between the target monitoring occasion and the reference change occasion” are equivalent or interchangeable.

In one embodiment, the expression of “the target HARQ-ACK bit block depending on a sequence between the target monitoring occasion and the reference change occasion” and the expression of “a first condition set comprising that the target monitoring occasion is before the reference change occasion: in the process of determining the target HARQ-ACK bit block: for the target monitoring occasion, if each condition in the first condition set is satisfied, skipping a generation of HARQ-ACK bit(s) corresponding to the target serving cell” are equivalent or interchangeable.

In one embodiment, the expression of “the target HARQ-ACK bit block depending on a sequence between the target monitoring occasion and the reference change occasion” and the expression of “a first condition set comprising that the target monitoring occasion is before the reference change occasion: in the process of determining the target HARQ-ACK bit block: for the target monitoring occasion: if each condition in the first condition set is satisfied, skipping a generation of HARQ-ACK bit(s) corresponding to the target serving cell, otherwise generating at least one HARQ-ACK bit corresponding to the target serving cell” are equivalent or interchangeable.

In one embodiment, the expression of “the target HARQ-ACK bit block depending on a sequence between the target monitoring occasion and the reference change occasion” and the expression of “a first condition set comprising that the target monitoring occasion is before the reference change occasion, and a second condition set comprising at least one condition related to the target monitoring occasion: in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell” are equivalent or interchangeable.

In one embodiment, the expression of “the target HARQ-ACK bit block depending on a sequence between the target monitoring occasion and the reference change occasion” and the expression of “a first condition set comprising that the target monitoring occasion is before the reference change occasion, and a second condition set comprising at least one condition related to the target monitoring occasion: in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell” are equivalent or interchangeable.

In one embodiment, in the present application, generating an operation of a HARQ-ACK bit comprises: an assignment operation for the HARQ-ACK bit.

In one embodiment, in the present application, generating an operation of a HARQ-ACK bit comprises: adding the HARQ-ACK bit.

In one embodiment, a sequence between the target monitoring occasion and the reference change occasion comprises: whether the target monitoring occasion is before the reference change occasion.

In one embodiment, a sequence between the target monitoring occasion and the reference change occasion comprises: whether the target monitoring occasion is after the reference change occasion.

In one embodiment, a sequence between the target monitoring occasion and the reference change occasion comprises: a sequence of the target monitoring occasion and the reference change occasion in time domain.

In one embodiment, the same active BWP is an active BWP of the target serving cell.

In one embodiment, the same active BWP is an active downlink BWP of the target serving cell.

In one embodiment, the same active BWP is an active uplink BWP of a PCell.

In one embodiment, the same active BWP is an active uplink BWP of a serving cell transmitted by a PUCCH.

In one embodiment, the first-type configuration change is triggered by a DCI format.

In one embodiment, the first-type configuration change is triggered by a physical-layer signaling.

In one embodiment, the first-type configuration change is triggered by a configuration based on a higher-layer signaling.

In one embodiment, the first-type configuration change is triggered by a configuration based on an RRC signaling.

In one embodiment, the first-type configuration change is triggered by a MAC CE.

In one embodiment, the first-type configuration change is triggered by an expiration of a timer.

In one embodiment, the first-type configuration change is triggered by a start or restart of a timer.

In one embodiment, the expression of “a sequence between the target monitoring occasion and the reference change occasion” and “a sequence between the target monitoring occasion and the first-type configuration change” are equivalent or interchangeable.

In one embodiment, the expression of “the target monitoring occasion is before the reference change occasion” and “the target monitoring occasion being before a first-type configuration change” are equivalent or interchangeable.

In one embodiment, the expression of “the target monitoring occasion not being before the reference change occasion” and “the target monitoring occasion not being before the first-type configuration change” are equivalent or interchangeable.

In one embodiment, the expression of “a reference change occasion comprising time occupied by the first-type configuration change, the target HARQ-ACK bit block depending on a sequence between the target monitoring occasion and the reference change occasion” and “the target HARQ-ACK bit block depending on a sequence between the target monitoring occasion and a reference configuration change, the reference configuration change being the first-type configuration change” are equivalent or interchangeable.

In one embodiment, the expression of “a sequence between the target monitoring occasion and the reference change occasion” and “a sequence between the target monitoring occasion and a reference configuration change” are equivalent or interchangeable.

In one embodiment, the expression of “the target monitoring occasion is before the reference change occasion” and “the target monitoring occasion is before a reference configuration change” are equivalent or interchangeable.

In one embodiment, the expression of “the target monitoring occasion not being before the reference change occasion” and “the target monitoring occasion not being before a reference configuration change” are equivalent or interchangeable.

In one embodiment, the reference configuration change is the first-type configuration change.

In one embodiment, the reference change occasion comprises time occupied by the reference configuration change.

In one embodiment, the reference change occasion is time occupied by the reference configuration change.

In one embodiment, a transmission of the target HARQ-ACK bit block is not before the reference configuration change.

In one embodiment, a transmission of the target HARQ-ACK bit block is not before the reference change occasion.

In one embodiment, the expression of “a reference change occasion comprising time occupied by the first-type configuration change, and the target HARQ-ACK bit block depending on a sequence between the target monitoring occasion and the reference change occasion” comprises:

in the process of determining the target HARQ-ACK bit block: in a loop for the target monitoring occasion and the target serving cell, whether there exists an operation to generate at least one HARQ-ACK bit depending on a sequence between the target monitoring occasion and the reference configuration change.

In one embodiment, the expression of “a reference change occasion comprising time occupied by the first-type configuration change, and the target HARQ-ACK bit block depending on a sequence between the target monitoring occasion and the reference change occasion” comprises: a determination of the target HARQ-ACK bit block depending on a sequence between the target monitoring occasion and the reference configuration change.

In one embodiment, the expression of “a reference change occasion comprising time occupied by the first-type configuration change, and the target HARQ-ACK bit block depending on a sequence between the target monitoring occasion and the reference change occasion” comprises:
in the process of determining the target HARQ-ACK bit block: for the target monitoring occasion, whether to skip a generation of HARQ-ACK bit(s) corresponding to the target serving cell depends on a sequence between the target monitoring occasion and the reference configuration change.

In one embodiment, the expression of “a reference change occasion comprising time occupied by the first-type configuration change, and the target HARQ-ACK bit block depending on a sequence between the target monitoring occasion and the reference change occasion” comprises:
a first condition set comprises that the target monitoring occasion is before a reference configuration change; in the process of determining the target HARQ-ACK bit block: for the target monitoring occasion, if each condition in the first condition set is satisfied, skipping a generation of HARQ-ACK bit(s) corresponding to the target serving cell.

In one embodiment, the expression of “a reference change occasion comprising time occupied by the first-type configuration change, and the target HARQ-ACK bit block depending on a sequence between the target monitoring occasion and the reference change occasion” comprises:
a first condition set comprises that the target monitoring occasion is before a reference configuration change; in the process of determining the target HARQ-ACK bit block: for the target monitoring occasion: if each condition in the first condition set is satisfied, skipping a generation of HARQ-ACK bit(s) corresponding to the target serving cell, otherwise generating at least one HARQ-ACK bit corresponding to the target serving cell.

In one embodiment, the expression of “a reference change occasion comprising time occupied by the first-type configuration change, and the target HARQ-ACK bit block depending on a sequence between the target monitoring occasion and the reference change occasion” comprises:
a first condition set comprises that the target monitoring occasion is before a reference configuration change, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

In one embodiment, the expression of “a reference change occasion comprising time occupied by the first-type configuration change, and the target HARQ-ACK bit block depending on a sequence between the target monitoring occasion and the reference change occasion” comprises:
a first condition set comprises that the target monitoring occasion is before a reference configuration change, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell.

In one embodiment, the expression of “the target HARQ-ACK bit block depending on a sequence between the target monitoring occasion and the reference configuration change” and the expression of “in the process of determining the target HARQ-ACK bit block: in a loop for the target monitoring occasion and the target serving cell, whether there exists an operation of generating at least one HARQ-ACK bit depending on a sequence between the target monitoring occasion and the reference configuration change, and the reference configuration change being the first-type configuration change” are equivalent or interchangeable.

In one embodiment, the expression of “the target HARQ-ACK bit block depending on a sequence of the target monitoring occasion and a reference configuration change” and the expression of “a determination of the target HARQ-ACK bit block depending on a sequence between the target monitoring occasion and a reference configuration change, and the reference configuration change being the first-type configuration change” are equivalent or interchangeable.

In one embodiment, the expression of “the target HARQ-ACK bit block depending on a sequence between the target monitoring occasion and the reference configuration change” and the expression of “in the process of determining the target HARQ-ACK bit block: for the target monitoring occasion, whether to skip a generation of HARQ-ACK bit(s) corresponding to the target serving cell depending on a sequence between the target monitoring occasion and the reference configuration change, and the reference configuration change being the first-type configuration change” are equivalent or interchangeable.

In one embodiment, the expression of “the target HARQ-ACK bit block depending on a sequence between the target monitoring occasion and a reference configuration change” and the expression of “a first condition set comprising that the target monitoring occasion is before a reference configuration change, the reference configuration change being the first-type configuration change; in the process of determining the target HARQ-ACK bit block: for the target monitoring occasion, if each condition in the first condition set is satisfied, skipping a generation of HARQ-ACK bit(s) corresponding to the target serving cell” are equivalent or interchangeable.

In one embodiment, the expression of “the target HARQ-ACK bit block depending on a sequence of the target monitoring occasion and a reference configuration change” and the expression of “a first condition set comprising that the target monitoring occasion being before a reference configuration change, and the reference configuration change being the first-type configuration change: in the process of determining the target HARQ-ACK bit block: for the target monitoring occasion: if each condition in the first condition set is satisfied, skipping a generation of HARQ-ACK bit(s) corresponding to the target serving cell, otherwise generating at least one HARQ-ACK bit corresponding to the target serving cell” are equivalent or interchangeable.

In one embodiment, the expression of “the target HARQ-ACK bit block depending on a sequence the target monitoring occasion and a reference configuration change” and the expression of “a first condition set comprising that the target monitoring occasion being before a reference configuration change, the reference configuration change being the first-type configuration change, and a second condition set comprising at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell” are equivalent or interchangeable.

In one embodiment, the expression of “the target HARQ-ACK bit block depending on a sequence of the target monitoring occasion and a reference configuration change” and the expression of “a first condition set comprising that the target monitoring occasion being before a reference configuration change, the reference configuration change being the first-type configuration change, and a second condition set comprising at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell” are equivalent or interchangeable.

### Embodiment 2

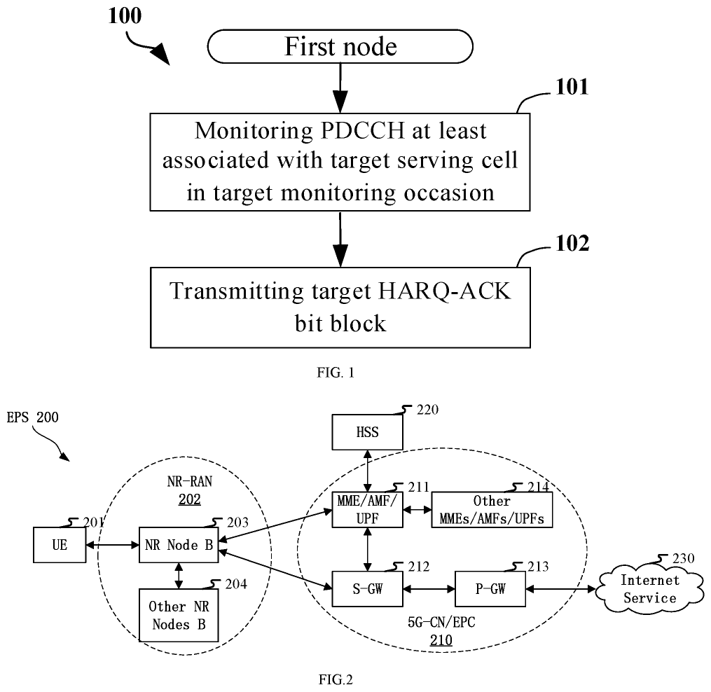

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMES/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 corresponds to the second node in the present application.

In one embodiment, the UE 201 is a UE.

In one embodiment, the UE 201 is a UE supporting multicast.

In one embodiment, the UE 201 is a regular UE.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station supporting large delay differences.

In one embodiment, the gNB 203 is a flight platform.

In one embodiment, the gNB 203 is satellite equipment.

In one embodiment, the gNB 203 is a base station that enables network energy-saving enhancement.

In one embodiment, both the first node and the second node in the present application correspond to the UE 201, for example, V2X communications are executed between the first node and the second node.

### Embodiment 3

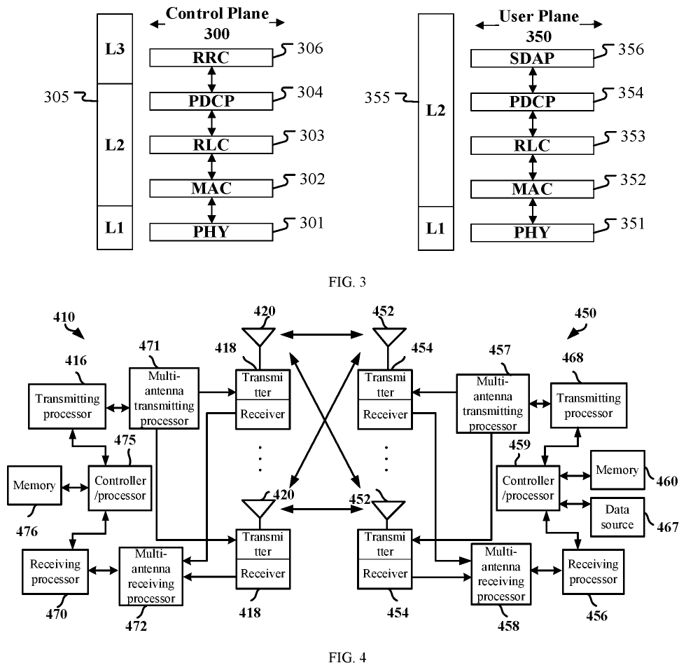

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, a PDCCH in the present application is generated by the PHY 301.

In one embodiment, the first PDSCH in the present application is generated by the PHY 301.

### Embodiment 4

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second node is a UE, and the first node is a base station.

In one subembodiment of the above embodiment, the second node is a relay node, and the first node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: monitors a PDCCH at least associated with a target serving cell in a target monitoring occasion, the target serving cell is a configured serving cell; transmits a target HARQ-ACK bit block; herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: monitoring a PDCCH at least associated with a target serving cell in a target monitoring occasion, the target serving cell being a configured serving cell; transmitting a target HARQ-ACK bit block; herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a PDCCH associated with a target serving cell in a target monitoring occasion, the target serving cell is a configured serving cell; receives a target HARQ-ACK bit block; herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting a PDCCH associated with a target serving cell in a target monitoring occasion, the target serving cell being a configured serving cell; receiving a target HARQ-ACK bit block; herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460 or the data source 467 is used to receives a PDCCH in the present application.

In one embodiment, at least one of the antenna 420, the transmitter 418, the multi-antenna transmitting processor 471, the transmitting processor 416, the controller/processor 475 or the memory 476 is used to transmit a PDCCH in the present application.

In one embodiment, at least one of the antenna 452, the receiver 454, the multi-antenna receiving processor 458, the receiving processor 456, the controller/processor 459, the memory 460 or the data source 467 is used to receive the first PDSCH in the present application.

In one embodiment, at least one of the antenna 420, the transmitter 418, the multi-antenna transmitting processor 471, the transmitting processor 416, the controller/processor 475 or the memory 476 is used to transmit the first PDSCH in the present application.

In one embodiment, at least one of the antenna 452, the transmitter 454, the multi-antenna transmitting processor 458, the transmitting processor 468, the controller/processor 459, the memory 460, or the data sources 467 is used to transmit the target HARQ-ACK bit block in the present application.

In one embodiment, at least one of the antenna 420, the receiver 418, the multi-antenna receiving processor 472, the receiving processor 470, the controller/processor 475, or the memory 476 is used to receive the target HARQ-ACK bit block in the present application.

### Embodiment 5

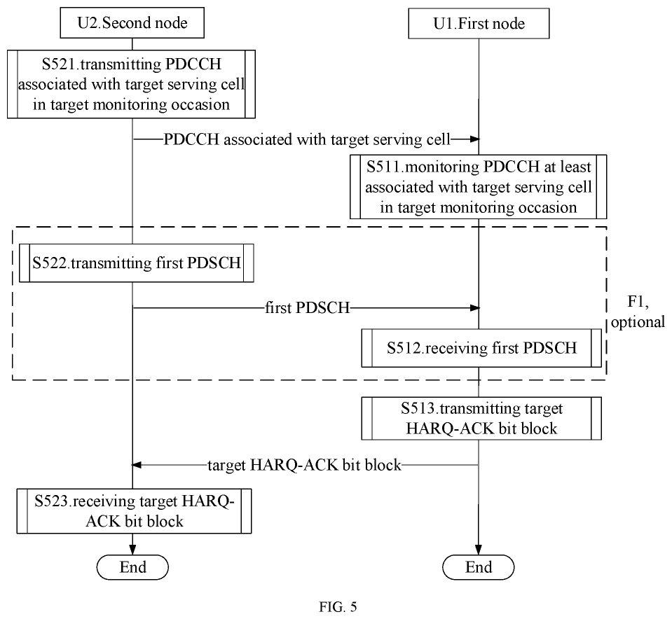

Embodiment 5 illustrates a flowchart of signal transmission according to one embodiment in the present application, as shown in FIG. 5. In FIG. 5, a first node U1 and a second node U2 are in communications via an air interface. Specifically, in FIG. 5, steps in dotted box F 1 are optional.

The first node U1 monitors a PDCCH at least associated with a target serving cell in a target monitoring occasion in step S511; receives a first PDSCH in step S512; transmits a target HARQ-ACK bit block in step S513.

The second node U2 transmits a PDCCH associated with a target serving cell in a target monitoring occasion in step S521; transmits a first PDSCH in step S522; receives a target HARQ-ACK bit block in step S523.

In embodiment 5, the first PDSCH is a PDSCH on the target serving cell, and the target serving cell is a configured serving cell; a first-type configuration change comprises a change in frequency-band resources, and the first-type configuration change occurs within a same active BWP; a reference change occasion comprises time occupied by the first-type configuration change; a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell; multiple frequency-band resources are configured for the same active BWP, and the first-type configuration change comprises switching among the multiple frequency-band resources within the same active BWP.

In one subembodiment of embodiment 5, an IE BWP-Downlink used to configure the same active BWP comprises a first parameter set, within the same active BWP, each parameter in the first parameter set is adopted both before and after the first-type configuration change occurs, or, an IE BWP-Uplink used to configure the same active BWP comprises a first parameter set, within the same active BWP, each parameter in the first parameter set is adopted both before and after the first-type configuration change occurs.

In one subembodiment of embodiment 5, a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

In one subembodiment of embodiment 5, a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell; an IE BWP-Downlink used to configure the same active BWP comprises a first parameter set, within the same active BWP, each parameter in the first parameter set is adopted both before and after the first-type configuration change occurs, or, an IE BWP-Uplink used to configure the same active BWP comprises a first parameter set, within the same active BWP, each parameter in the first parameter set is adopted both before and after the first-type configuration change occurs.

In one embodiment, the first node U1 is the first node in the present application.

In one embodiment, the second node U2 is the second node in the present application.

In one embodiment, the first node U 1 is a UE.

In one embodiment, the first node U 1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U 1 comprises a cellular link.

In one embodiment, an air interface between the second node U2 and the first node U1 is a PC5 interface.

In one embodiment, an air interface between the second node U2 and the first node U1 comprises a sidelink.

In one embodiment, an air interface between the second node U2 and the first node U1 comprises a radio interface between a base station and a UE.

In one embodiment, an air interface between the second node U2 and the first node U1 comprises a radio interface between satellite and a UE.

In one embodiment, an air interface between the second node U2 and the first node U1 comprises a radio interface between a UE and a UE.

In one embodiment, a problem to be solved in the present application comprises: how to reduce the overhead of HARQ-ACK feedback.

In one embodiment, a problem to be solved in the present application comprises: how to reduce the feedback overhead of a second-type HARQ-ACK codebook.

In one embodiment, a problem to be solved in the present application comprises: how to optimize the system design.

In one embodiment, a problem to be solved in the present application comprises: how to reduce operating costs.

In one embodiment, a problem to be solved in the present application comprises: how to reduce the overhead of a control signaling.

In one embodiment, a problem to be solved in the present application comprises: how to reduce energy consumption of the base station and the terminal.

In one embodiment, a problem to be solved in the present application comprises: how to determine the target HARQ-ACK bit block based on at least the reference change occasion.

In one embodiment, a problem to be solved in the present application comprises: how to generate HARQ-ACK codebooks considering changes in frequency-band resources.

In one embodiment, the steps marked by the dotted-line box F1 exist.

In one embodiment, the steps marked by the dotted-line box F1 do not exist.

In one embodiment, at least the step S522 in dotted box F1 exists.

In one embodiment, at least the step S512 in dotted box F1 does not exist.

In one embodiment, when the target monitoring occasion is before the reference change occasion, steps in the dotted box F1 exist or do not exist; when the target monitoring occasion is not before the reference change occasion, steps in the dotted box F1 exist.

In one embodiment, when the target monitoring occasion is before the reference change occasion, at least the step S522 in the dotted box F1 exists; when the target monitoring occasion is not before the reference change occasion, steps in the dotted box F1 exist.

### Embodiment 6

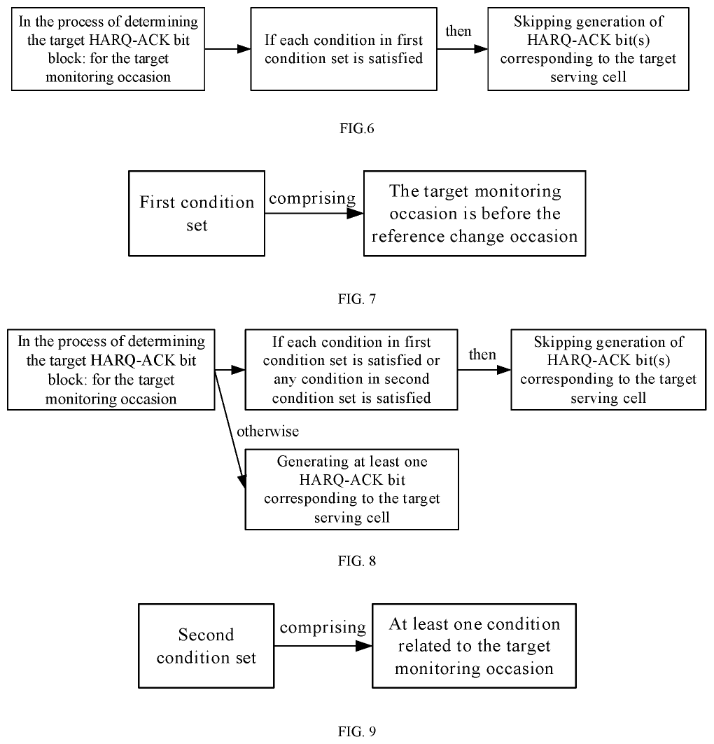

Embodiment 6 illustrates a schematic diagram of relations among a target HARQ-ACK bit block, a target monitoring occasion, a first condition set as well as a target serving cell according to one embodiment of the present application, as shown in FIG. 6.

In embodiment 6, in the process of determining the target HARQ-ACK bit block: for the target monitoring occasion, if each condition in the first condition set is satisfied, skip a generation of HARQ-ACK bit(s) corresponding to the target serving cell.

In one embodiment, in the process of determining the target HARQ-ACK bit block: for the target monitoring occasion, if each condition in the first condition set is satisfied, skip a generation of HARQ-ACK bit(s) corresponding to the target serving cell, otherwise generate at least one HARQ-ACK bit corresponding to the target serving cell.

In one embodiment, the expression of for the target monitoring occasion comprises: for a PDCCH monitoring occasion index corresponding to the target monitoring occasion.

In one embodiment, the expression of for the target monitoring occasion comprises: executing at least one loop for variable m, in a loop for the variable m after the variable m is assigned a value equal to a PDCCH monitoring occasion index corresponding to the target monitoring occasion.

In one embodiment, each condition in the first condition set being satisfied refers to: all conditions in the first condition set are satisfied.

In one embodiment, a HARQ-ACK bit corresponding to the target serving cell is: a HARQ-ACK bit corresponding to at least one TB of the target serving cell.

In one embodiment, a HARQ-ACK bit corresponding to the target serving cell is: a result of binary and operation on multiple HARQ-ACK bits respectively corresponding to multiple TB s of the target serving cell.

In one embodiment, a HARQ-ACK bit corresponding to the target serving cell is: HARQ-ACK bits used to indicate a decoding result of a TB in a PDSCH reception on the target serving cell.

In one embodiment, a HARQ-ACK bit corresponding to the target serving cell is: a HARQ-ACK bit of the target serving cell.

In one embodiment, a HARQ-ACK bit in the present application is a HARQ-ACK information bit.

In one embodiment, a first condition set comprises that the target monitoring occasion is before the reference change occasion; in the process of determining the target HARQ-ACK bit block: for the target monitoring occasion: if each condition in the first condition set is satisfied, skipping a generation of HARQ-ACK bit(s) corresponding to the target serving cell, otherwise generating at least one HARQ-ACK bit corresponding to the target serving cell.

In one embodiment, for the target monitoring occasion: if a generation of HARQ-ACK bits corresponding to the target serving cell is skipped, the target bit block does not comprise a HARQ-ACK bit for the target serving cell.

In one embodiment, skipping a generation of HARQ-ACK bit(s) corresponding to the target serving cell comprises the following meaning: not executing an operation of generating a HARQ-ACK bit corresponding to the target serving cell.

In one embodiment, not skipping a generation of HARQ-ACK bit(s) corresponding to the target serving cell comprises the following meaning: generating at least one HARQ-ACK bit corresponding to the target serving cell.

In one embodiment, skipping a generation of HARQ-ACK bit(s) corresponding to the target serving cell comprises the following meaning: in a loop after variable c is assigned a value equal to a serving cell index of the target serving cell: before executing c=c+1 on the variable c, not executing an operation of generating a HARQ-ACK bit corresponding to the target serving cell.

In one embodiment, not skipping a generation of HARQ-ACK bit(s) corresponding to the target serving cell comprises the following meaning: in a loop after variable c is assigned a value equal to a serving cell index of the target serving cell: before executing c=c+1 on the variable c, executing at least one operation of generating a HARQ-ACK bit corresponding to the target serving cell.

In one embodiment, the meaning of skipping a generation of HARQ-ACK bit(s) corresponding to the target serving cell is: not executing an operation of generating a HARQ-ACK bit corresponding to the target serving cell.

In one embodiment, the meaning of not skipping a generation of HARQ-ACK bit(s) corresponding to the target serving cell is: generating at least one HARQ-ACK bit corresponding to the target serving cell.

In one embodiment, the meaning of skipping a generation of HARQ-ACK bit(s) corresponding to the target serving cell is: in a loop after variable c is assigned a value equal to a serving cell index of the target serving cell: before executing c=c+1 on the variable c, not executing an operation of generating a HARQ-ACK bit corresponding to the target serving cell.

In one embodiment, the meaning of not skipping a generation of HARQ-ACK bit(s) corresponding to the target serving cell is: in a loop after variable c is assigned a value equal to a serving cell index of the target serving cell: before executing c=c+1 on the variable c, executing at least one operation of generating a HARQ-ACK bit corresponding to the target serving cell.

In one embodiment, generating at least one HARQ-ACK bit corresponding to the target serving cell comprises the following meaning: in a loop after variable c is assigned a value equal to a serving cell index of the target serving cell: before executing c=c+1 on the variable c, executing at least one operation of generating a HARQ-ACK bit corresponding to the target serving cell.

In one embodiment, the meaning of generating at least one HARQ-ACK bit corresponding to the target serving cell is: in a loop after variable c is assigned a value equal to a serving cell index of the target serving cell: before executing c=c+1 on the variable c, executing at least one operation of generating a HARQ-ACK bit corresponding to the target serving cell.

In one embodiment, generating at least one HARQ-ACK bit corresponding to the target serving cell comprises the following meaning: assigning a value of at least one HARQ-ACK bit corresponding to the target serving cell to at least one HARQ-ACK bit in the target HARQ-ACK bit block.

In one embodiment, the meaning of generating at least one HARQ-ACK bit corresponding to the target serving cell is: assigning a value of at least one HARQ-ACK bit corresponding to the target serving cell to at least one HARQ-ACK bit in the target HARQ-ACK bit block.

In one embodiment, generating at least one HARQ-ACK bit corresponding to the target serving cell comprises the following meaning: not skipping a generation of HARQ-ACK bit(s) corresponding to the target serving cell.

In one embodiment, the meaning of generating at least one HARQ-ACK bit corresponding to the target serving cell is: not skipping a generation of HARQ-ACK bit(s) corresponding to the target serving cell.

In one embodiment, at least one HARQ-ACK bit corresponding to the target serving cell for the target monitoring occasion is a HARQ-ACK bit indicating whether a TB in the first PDSCH is correctly decoded.

### Embodiment 7

Embodiment 7 illustrates a schematic diagram of a first condition set according to one embodiment of the present application, as shown in FIG. 7.

In embodiment 7, a first condition set comprises: the target monitoring occasion is before the reference change occasion.

In one embodiment, the expression of the target monitoring occasion being before the reference change occasion comprises: a start time of the target monitoring occasion is earlier than a start time of the reference change occasion.

In one embodiment, the expression of the target monitoring occasion being before the reference change occasion comprises: an end time of the target monitoring occasion is earlier than a start time of the reference change occasion.

In one embodiment, the expression of the target monitoring occasion being before the reference change occasion comprises: an end time of the target monitoring occasion is earlier than an end time of the reference change occasion.

In one embodiment, the expression of the target monitoring occasion being before the reference change occasion comprises: a slot occupied by the target monitoring occasion is before a slot occupied by the reference change occasion.

In one embodiment, the expression of the target monitoring occasion being before the reference change occasion comprises: a symbol occupied by the target monitoring occasion is before a symbol occupied by the reference change occasion.

In one embodiment, the expression of the target monitoring occasion being before the reference change occasion refers to: a start time of the target monitoring occasion is earlier than a start time of the reference change occasion.

In one embodiment, the expression of the target monitoring occasion being before the reference change occasion refers to: an end time of the target monitoring occasion is earlier than a start time of the reference change occasion.

In one embodiment, the expression of the target monitoring occasion being before the reference change occasion refers to: an end time of the target monitoring occasion is earlier than an end time of the reference change occasion.

In one embodiment, the expression of the target monitoring occasion being before the reference change occasion refers to: a slot occupied by the target monitoring occasion is before a slot occupied by the reference change occasion.

In one embodiment, the expression of the target monitoring occasion being before the reference change occasion refers to: a symbol occupied by the target monitoring occasion is before a symbol occupied by the reference change occasion.

In one embodiment, the first condition set only comprises a condition.

In one embodiment, one condition in the first condition set is related to a sequence between the target monitoring occasion and the reference change occasion.

In one embodiment, one condition in the first condition set is based on a sequence between the target monitoring occasion and the reference change occasion.

In one embodiment, the first condition set only comprises: the target monitoring occasion is before the reference change occasion.

In one embodiment, the first condition set comprises multiple conditions.

In one embodiment, the first condition set also comprises: the first-type configuration change is not triggered in the target monitoring occasion

In one embodiment, the first condition set also comprises: the first-type configuration change is not triggered in the target monitoring occasion

In one embodiment, the first condition set also comprises: no first-type configuration change is triggered by a DCI format in the target monitoring occasion.

In one embodiment, the first condition set also comprises: the first-type configuration change is not triggered by a DCI format in the target monitoring occasion.

In one embodiment, the first condition set also comprises: an active downlink BWP change is not triggered in the target monitoring occasion.

In one embodiment, an active downlink BWP change is not triggered in the target monitoring occasion.

In one embodiment, the target monitoring occasion is not before an active DL BWP change on the target serving cell.

In one embodiment, the target monitoring occasion is not before an active UL BWP change on a PCell.

In one embodiment, the target monitoring occasion is not before an active UL BWP change on a serving cell of a PUCCH transmission.

In one embodiment, one condition in the first condition set is related to a PDCCH in the target monitoring occasion.

In one embodiment, one condition in the first condition set is related to a reception of a PDSCH.

In one embodiment, one condition in the first condition set is based on a condition of a PDCCH in at least the target monitoring occasion.

In one embodiment, one condition in the first condition set is based on a condition of reception of at least a PDSCH.

In one embodiment, the first condition set also comprises: there does not exist a PDSCH associated with a PDCCH in the target monitoring occasion that provides a TB for a HARQ process with enabled HARQ-ACK information on the target serving cell.

In one embodiment, the first condition set also comprises: there does not exist a PDCCH that provides a DCI format associated with HARQ-ACK information without scheduling a PDSCH reception on the target serving cell.

In one embodiment, the first condition set also comprises: there exists no PDSCH reception scheduled by DCI format 4_2 of corresponding HARQ-ACK information.

In one embodiment, in the process of determining the target HARQ-ACK bit block: for the target monitoring occasion, if each condition in the first condition set is satisfied, skipping a generation of HARQ-ACK bit(s) corresponding to the target serving cell.

In one embodiment, in the process of determining the target HARQ-ACK bit block: for the target monitoring occasion, if each condition in the first condition set is not satisfied, skipping a generation of HARQ-ACK bit(s) corresponding to the target serving cell.

In one embodiment, in the process of determining the target HARQ-ACK bit block: for the target monitoring occasion, if any condition in the first condition set is satisfied, skipping a generation of HARQ-ACK bit(s) corresponding to the target serving cell.

In one embodiment, in the process of determining the target HARQ-ACK bit block: for the target monitoring occasion, if any condition in the first condition set is not satisfied, skipping a generation of HARQ-ACK bit(s) corresponding to the target serving cell.

### Embodiment 8

Embodiment 8 illustrates a schematic diagram of relations among a target HARQ-ACK bit block, a target monitoring occasion, a first condition set, a second condition set as well as a target serving cell according to one embodiment of the present application, as shown in FIG. 8.

In embodiment 8, a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

### Embodiment 9

Embodiment 9 illustrates a schematic diagram of a second condition set according to one embodiment of the present application, as shown in FIG. 9.

In embodiment 9, a second condition set comprises at least one condition related to the target monitoring occasion.

In one embodiment, the second condition set comprises at least one condition.

In one embodiment, the second condition set only comprises one condition.

In one embodiment, the second condition set comprises multiple conditions.

In one embodiment, at least one condition in the second condition set is based on at least the target monitoring occasion.

In one embodiment, at least one condition in the second condition set is related to a BWP change.

In one embodiment, at least one condition in the second condition set is related to an active downlink BWP change.

In one embodiment, at least one condition in the second condition set is related to an active uplink BWP change.

In one embodiment, one condition in the second condition set is based on a sequence between at least the target monitoring occasion and an active downlink BWP change.

In one embodiment, one condition in the second condition set is based on a sequence between at least the target monitoring occasion and an active uplink BWP change.

In one embodiment, one condition in the second condition set is related to a sequence between the target monitoring occasion and an active downlink BWP change.

In one embodiment, one condition in the second condition set is related to a sequence between the target monitoring occasion and an active uplink BWP change.

In one embodiment, the second condition set comprises: the target monitoring occasion being before an active DL BWP change on the target serving cell.

In one embodiment, the second condition set comprises: the target monitoring occasion being before an active UL BWP change on a PCell.

In one embodiment, the second condition set comprises: the target monitoring occasion being before an active UL BWP change on a serving cell of a PUCCH transmission.

In one embodiment, the second condition set comprises: the target monitoring occasion being before an active DL BWP change on the target serving cell, and the active DL BWP change is not triggered in the target monitoring occasion.

In one embodiment, the second condition set comprises: the target monitoring occasion being before an active UL BWP change on a PCell, and the active DL BWP change not being triggered in the target monitoring occasion.

In one embodiment, the second condition set comprises: the target monitoring occasion being before the active uplink BWP change on a serving cell of a PUCCH transmission, and the active downlink BWP change not being triggered in the target monitoring occasion.

In one embodiment, the second condition set comprises: the target monitoring occasion being before an active DL BWP change on the target serving cell, and the active DL BWP change not being triggered in the target monitoring occasion, and the first-type configuration change not being triggered in the target monitoring occasion.

In one embodiment, the second condition set comprises: the target monitoring occasion being before an active UL BWP change on a PCell, and the active DL BWP change not being triggered in the target monitoring occasion, and the first-type configuration change not being triggered in the target monitoring occasion.

In one embodiment, the second condition set comprises: the target monitoring occasion being before an active uplink BWP change on a serving cell of a PUCCH transmission, and the active downlink BWP change not being triggered in the target monitoring occasion, and the first-type configuration change not being triggered in the target monitoring occasion.

In one embodiment, one condition in the second condition set consists of multiple sub-conditions, and one of the multiple sub-conditions is: an active downlink BWP change not being triggered in the target monitoring occasion; the condition in the second condition set being satisfied refers to: the multiple sub-conditions being satisfied.

In one embodiment, one condition in the second condition set consists of multiple sub-conditions, and one of the multiple sub-conditions is: the first-type configuration change not being triggered in the target monitoring occasion; the condition in the second condition set being satisfied refers to: the multiple sub-conditions being satisfied.

In one embodiment, one condition in the second condition set consists of multiple sub-conditions, and one of the multiple sub-conditions is: the target monitoring occasion being before an active DL BWP change on the target serving cell; the condition in the second condition set being satisfied refers to: the multiple sub-conditions being satisfied.

In one embodiment, one condition in the second condition set consists of multiple sub-conditions, and one of the multiple sub-conditions is: the target monitoring occasion being before an active UL BWP change on a PCell; the condition in the second condition set being satisfied refers to: the multiple sub-conditions being satisfied.

In one embodiment, one condition in the second condition set consists of multiple sub-conditions, and one of the multiple sub-conditions is: the target monitoring occasion being before an active UL BWP change on a serving cell of a PUCCH transmission; the condition in the second condition set being satisfied refers to: the multiple sub-conditions being satisfied.

In one embodiment, one condition in the second condition set is a condition related to a reception of a PDSCH.

In one embodiment, one condition in the second condition set is a condition related to a reception of a PDCCH in the target monitoring occasion.

In one embodiment, one condition in the second condition set is based on a reception of at least PDSCH.

In one embodiment, one condition in the second condition set is based on a reception of a PDCCH in at least the target monitoring occasion.

In one embodiment, the second condition set comprises: there does not exist a PDSCH associated with a PDCCH in the target monitoring occasion that provides a TB for a HARQ process with enabled HARQ-ACK information on the target serving cell, and there does not exist a PDCCH that provides a DCI format associated with HARQ-ACK information without scheduling a PDSCH reception on the target serving cell.

In one embodiment, the second condition set comprises: there does not exist a PDSCH associated with a PDCCH in the target monitoring occasion that provides a TB for a HARQ process with enabled HARQ-ACK information on the target serving cell, and there does not exist a PDCCH that provides a DCI format associated with HARQ-ACK information without scheduling a PDSCH reception on the target serving cell, and there does not exist a PDSCH reception scheduled by DCI format 4_2 indicating an absence of corresponding HARQ-ACK information.

In one embodiment, one condition in the second condition set consists of multiple sub-conditions, and one of the multiple sub-conditions is: there does not exist a PDSCH associated with a PDCCH in the target monitoring occasion that provides a TB for a HARQ process with enabled HARQ-ACK information on the target serving cell; the condition in the second condition set being satisfied refers to: the multiple sub-conditions are satisfied.

In one embodiment, one condition in the second condition set consists of multiple sub-conditions, and one of the multiple sub-conditions is: there does not exist a PDCCH that provides a DCI format associated with HARQ-ACK information without scheduling a PDSCH reception on the target serving cell; the condition in the second condition set being satisfied refers to: the multiple sub-conditions are satisfied.

In one embodiment, one condition in the second condition set consists of multiple sub-conditions, and one of the multiple sub-conditions is: there does not exist a PDSCH reception scheduled by DCI format 4_2 indicating an absence of corresponding HARQ-ACK information; the condition in the second condition set being satisfied refers to: the multiple sub-conditions are satisfied.

In one embodiment, a first condition set comprises that the target monitoring occasion is before the reference change occasion.

In one embodiment, a second condition set comprises at least one condition related to the target monitoring occasion.

In one embodiment, in the process of determining the target HARQ-ACK bit block: for the target monitoring occasion, if each condition in the first condition set is satisfied or any condition in the second condition set is satisfied, skipping a generation of HARQ-ACK bit(s) corresponding to the target serving cell.

In one embodiment, in the process of determining the target HARQ-ACK bit block: for the target monitoring occasion, if each condition in the first condition set is satisfied or any condition in the second condition set is satisfied, skipping a generation of HARQ-ACK bit(s) corresponding to the target serving cell; otherwise, generating at least one HARQ-ACK bit corresponding to the target serving cell.

In one embodiment, in the process of determining the target HARQ-ACK bit block: for the target monitoring occasion, if each condition in the first condition set is satisfied or any condition in the second condition set is satisfied, then generating at least one HARQ-ACK bit corresponding to the target serving cell; otherwise, skipping a generation of HARQ-ACK bit(s) corresponding to the target serving cell.

### Embodiment 10

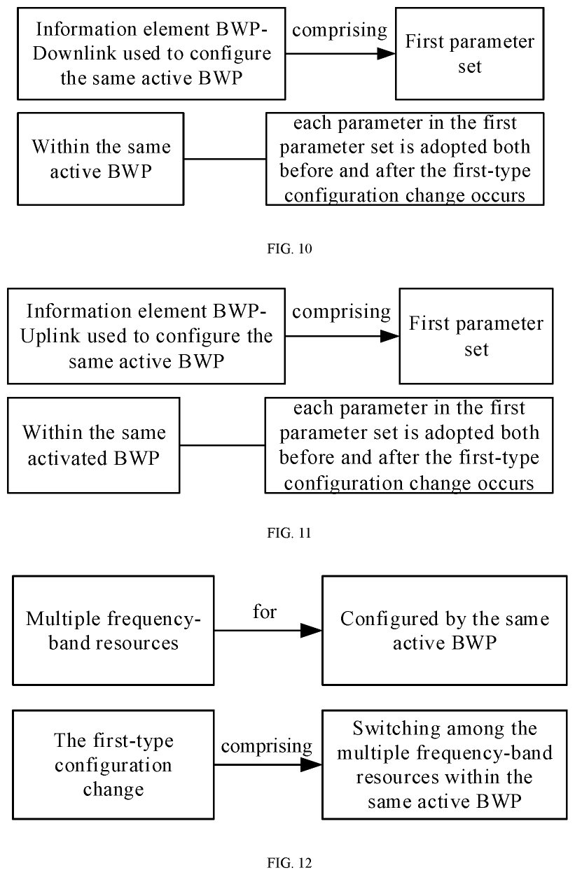

Embodiment 10 illustrates a schematic diagram of relations among a first-type configuration change, a same active BWP as well as a first parameter set according to one embodiment of the present application, as shown in FIG. 10.

In embodiment 10, an IE BWP-Downlink used to configure the same active BWP comprises a first parameter set, within the same active BWP, each parameter in the first parameter set is adopted both before and after the first-type configuration change occurs.

In one embodiment, the same active BWP is an active DL BWP.

In one embodiment, the first parameter set comprises an identifier (ID) of BWP.

In one embodiment, the first parameter set comprises configuration parameters for subcarrier spacing.

In one embodiment, the first parameter set comprises configuration parameters of whether an extended cyclic prefix is used.

In one embodiment, the first parameter set comprises pdcch-ConfigCommon.

In one embodiment, the first parameter set comprises pdsch-ConfigCommon.

In one embodiment, the first parameter set comprises at least one RRC-layer parameter.

In one embodiment, an IE BWP-DownlinkDedicated used to configure the same active BWP comprises a first parameter set, within the same active BWP, each parameter in the first parameter set is adopted both before and after the first-type configuration change occurs.

In one embodiment, an IE BWP-DownlinkCommon used to configure the same active BWP comprises a first parameter set, within the same active BWP, each parameter in the first parameter set is adopted both before and after the first-type configuration change occurs.

In one embodiment, the first parameter set comprises parameters used for configuring a PDSCH.

In one embodiment, the first parameter set comprises parameters used for configuring a PDCCH.

In one embodiment, the first parameter set comprises parameters used for configuring a DL SPS.

In one embodiment, the expression of adopting each parameter in the first parameter set both before and after the first-type configuration change occurs comprises: regardless of whether the first-type configuration change occurs, each parameter in the first parameter set remains effective.

In one embodiment, the expression of adopting each parameter in the first parameter set both before and after the first-type configuration change comprises: an occurrence of the first-type configuration change does not affect the effectiveness of each parameter in the first parameter set.

### Embodiment 11

Embodiment 11 illustrates a schematic diagram of relations among a first-type configuration change, a same active BWP as well as a first parameter set according to one embodiment of the present application, as shown in FIG. 11.

In embodiment 11, an IE BWP-Uplink used to configure the same active BWP comprises a first parameter set, within the same active BWP, each parameter in the first parameter set is adopted both before and after the first-type configuration change occurs.

In one embodiment, the same active BWP is an active UL BWP.

In one embodiment, the first parameter set comprises an identifier (ID) of a BWP.

In one embodiment, the first parameter set comprises configuration parameters for subcarrier spacing.

In one embodiment, the first parameter set comprises configuration parameters of whether an extended cyclic prefix is used.

In one embodiment, the first parameter set comprises rach-ConfigCommon.

In one embodiment, the first parameter set comprises pusch-ConfigCommon.

In one embodiment, the first parameter set comprises pucch-ConfigCommon.

In one embodiment, the first parameter set comprises at least one RRC-layer parameter.

In one embodiment, an IE BWP-UplinkDedicated used to configure the same active BWP comprises a first parameter set, within the same active BWP, each parameter in the first parameter set is adopted both before and after the first-type configuration change occurs.

In one embodiment, an IE BWP-UplinkCommon used to configure the same active BWP comprises a first parameter set, within the same active BWP, each parameter in the first parameter set is adopted both before and after the first-type configuration change occurs.

In one embodiment, the first parameter set comprises parameters used for configuring a PUSCH.

In one embodiment, the first parameter set comprises parameters used for configuring a PUCCH.

In one embodiment, the first parameter set comprises parameters used for configuring random access.

In one embodiment, the first parameter set comprises parameters used for configuring configured grant.

In one embodiment, the expression of adopting each parameter in the first parameter set both before and after the first-type configuration change occurs comprises: regardless of whether the first-type configuration change occurs, each parameter in the first parameter set remains effective.

In one embodiment, the expression of adopting each parameter in the first parameter set both before and after the first-type configuration change occurs comprises: an occurrence of the first-type configuration change does not affect the effectiveness of each parameter in the first parameter set.

### Embodiment 12

Embodiment 12 illustrates a schematic diagram of relations among a first-type configuration change, a same active BWP as well as multiple frequency-band resources according to one embodiment of the present application, as shown in FIG. 12.

In embodiment 12, multiple frequency-band resources are configured for the same active BWP, and the first-type configuration change comprises switching among the multiple frequency-band resources within the same active BWP.

In one embodiment, the switching occurred between multiple frequency-band resources comprises: the switching occurred between two of the multiple frequency-band resources.

In one embodiment, the switching occurred between multiple frequency-band resources comprises: the switching occurred between any two of the multiple frequency-band resources.

In one embodiment, the expression of the first-type configuration change comprising changes in frequency-band resources comprises: the first-type configuration change comprises switching occurred among the multiple frequency-band resources within the same active BWP.

In one embodiment, one of the multiple frequency-band resources is indicated by frequency-domain location and bandwidth

In one embodiment, any of the multiple frequency-band resources is indicated by frequency-domain location and bandwidth

In one embodiment, one of the multiple frequency-band resources comprises at least one resource block.

In one embodiment, one of the multiple frequency-band resources comprises at least one physical resource block.

In one embodiment, any of the multiple frequency-band resources comprises at least one resource block.

In one embodiment, any of the multiple frequency-band resources comprises at least one physical resource block.

In one embodiment, the multiple frequency-band resources are different from each other.

In one embodiment, the multiple frequency-band resources belong to the same active BWP.

In one embodiment, one of the multiple frequency-band resources is the same active BWP.

In one embodiment, the multiple frequency-band resources are configured in an IE BWP-Downlink used to configure the same active BWP.

In one embodiment, the multiple frequency-band resources are configured in an IE BWP-DownlinkDedicated used to configure the same active BWP.

In one embodiment, the multiple frequency-band resources are configured in an IE BWP-DownlinkCommon used to configure the same active BWP.

In one embodiment, the multiple frequency-band resources are configured in an IE BWP-Uplink used to configure the same active BWP.

In one embodiment, the multiple frequency-band resources are configured in an IE BWP-UplinkDedicated used to configure the same active BWP.

In one embodiment, the multiple frequency-band resources are configured in an IE BWP-UplinkCommon used to configure the same active BWP.

### Embodiment 13

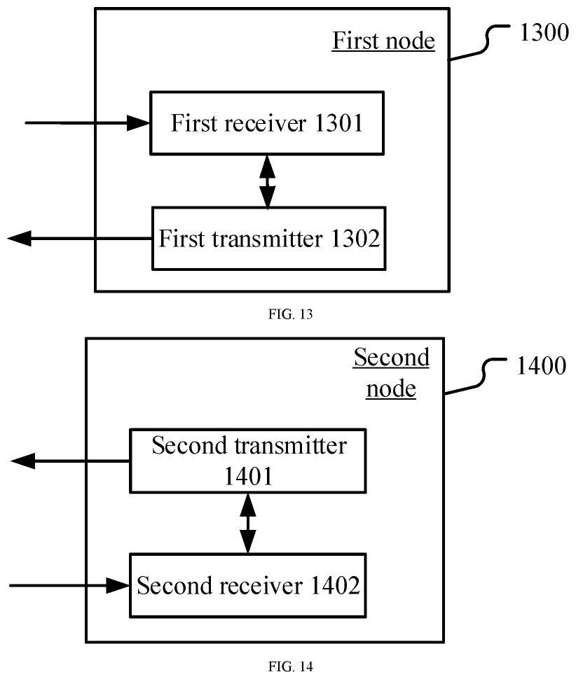

Embodiment 13 illustrates a structure block diagram of a processor in a first node, as shown in FIG. 13. In FIG. 13, a processor 1300 of a first node comprises a first receiver 1301 and a first transmitter 1302.

In one embodiment, the first node 1300 is a base station.

In one embodiment, the first node 1300 is a UE.

In one embodiment, the first node 1300 is a relay node.

In one embodiment, the first node 1300 is a vehicle-mounted communication device.

In one embodiment, the first node 1300 is a UE that supports V2X communications.

In one embodiment, the first node 1300 is a relay node that supports V2X communications.

In one embodiment, the first node 1300 is a UE that supports operations on a high-frequency spectrum.

In one embodiment, the first node 1300 is a UE that supports operations on a shared frequency spectrum.

In one embodiment, the first node 1300 is a UE that supports XR services.

In one embodiment, the first node 1300 is a UE that supports multicast transmission.

In one embodiment, the first receiver 1301 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1301 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1302 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1302 comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1302 comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1302 comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1302 comprises at least first two of the antenna 452, the transmitter 454, the multi-antenna transmitting processor 457, the transmitting processor 468, the controller/processor 459, the memory 460, and the data source 467 in FIG. 4 of the present application.

In one embodiment, the first receiver 1301 monitors a PDCCH at least associated with a target serving cell in a target monitoring occasion, the target serving cell is a configured serving cell; the first transmitter 1302 transmits a target HARQ-ACK bit block; herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one embodiment, in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

In one embodiment, a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell.

In one embodiment, a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

In one embodiment, if at least one HARQ-ACK bit corresponding to the target serving cell is generated for the target monitoring occasion in the process of determining the target HARQ-ACK bit block, the target HARQ-ACK bit block comprises the at least one HARQ-ACK bit corresponding to the target serving cell for the target monitoring occasion.

In one embodiment, an IE BWP-Downlink used to configure the same active BWP comprises a first parameter set, within the same active BWP, each parameter in the first parameter set is adopted both before and after the first-type configuration change occurs.

In one embodiment, an IE BWP-Uplink used to configure the same active BWP comprises a first parameter set, within the same active BWP, each parameter in the first parameter set is adopted both before and after the first-type configuration change occurs.

In one embodiment, multiple frequency-band resources are configured for the same active BWP, and the first-type configuration change comprises switching among the multiple frequency-band resources within the same active BWP.

### Embodiment 14

Embodiment 14 illustrates a structure block diagram of a processor in a second node, as shown in FIG. 14.

In FIG. 14, a processor 1400 of the second node comprises a second transmitter 1401 and a second receiver 1402.

In one embodiment, the second node 1400 is a UE.

In one embodiment, the second node 1400 is a base station.

In one embodiment, the second node 1400 is satellite.

In one embodiment, the second node 1400 is a relay node.

In one embodiment, the second node 1400 is a vehicle-mounted communication device.

In one embodiment, the second node 1400 is a UE supporting V2X communications.

In one embodiment, the second node 1400 is a device that supports operations on a high-frequency spectrum.

In one embodiment, the second node 1400 is a device that supports operations on a shared spectrum.

In one embodiment, the second node 1400 is a device that supports XR services.

In one embodiment, the second node 1400 is one of testing device, testing equipment, and testing instrument.

In one embodiment, the second transmitter 1401 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1401 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1402 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1402 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least first two of the antenna 420, the receiver 418, the multi-antenna receiving processor 472, the receiving processor 470, the controller/processor 475 and the memory 476 in FIG. 4 of the present application.

In one embodiment, the second transmitter 1401 transmits a PDCCH associated with a target serving cell in a target monitoring occasion, the target serving cell is a configured serving cell; the second receiver 1402 receives a target HARQ-ACK bit block; herein, a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

In one embodiment, in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

In one embodiment, a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell.

In one embodiment, a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

In one embodiment, if at least one HARQ-ACK bit corresponding to the target serving cell is generated for the target monitoring occasion in the process of determining the target HARQ-ACK bit block, the target HARQ-ACK bit block comprises the at least one HARQ-ACK bit corresponding to the target serving cell for the target monitoring occasion.

In one embodiment, an IE BWP-Downlink used to configure the same active BWP comprises a first parameter set, within the same active BWP, each parameter in the first parameter set is adopted both before and after the first-type configuration change occurs.

In one embodiment, an IE BWP-Uplink used to configure the same active BWP comprises a first parameter set, within the same active BWP, each parameter in the first parameter set is adopted both before and after the first-type configuration change occurs.

In one embodiment, multiple frequency-band resources are configured for the same active BWP, and the first-type configuration change comprises switching among the multiple frequency-band resources within the same active BWP.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, monitoring a PDCCH at least associated with a target serving cell in a target monitoring occasion, the target serving cell being a configured serving cell; and
a first transmitter, transmitting a target HARQ-ACK bit block;
wherein a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

2. The first node according to claim 1, wherein in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

3. The first node according to claim 1, wherein a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell.

4. The first node according to claim 1, wherein a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

5. The first node according to claim 1, wherein if at least one HARQ-ACK bit corresponding to the target serving cell is generated for the target monitoring occasion in the process of determining the target HARQ-ACK bit block, the target HARQ-ACK bit block comprises the at least one HARQ-ACK bit corresponding to the target serving cell for the target monitoring occasion.

6. The first node according to claim 2, wherein an Information Element (IE) BWP-Downlink used to configure the same active BWP comprises a first parameter set, within the same active BWP, each parameter in the first parameter set is adopted both before and after the first-type configuration change occurs; or, an IE BWP-Uplink used to configure the same active BWP comprises a first parameter set, within the same active BWP, each parameter in the first parameter set is adopted both before and after the first-type configuration change occurs.

7. The first node according to claim 1, wherein multiple frequency-band resources are configured for the same active BWP, and the first-type configuration change comprises switching among the multiple frequency-band resources within the same active BWP.

8. A second node for wireless communications, comprising:
a second transmitter, transmitting a PDCCH associated with a target serving cell in a target monitoring occasion, the target serving cell being a configured serving cell; and
a second receiver, receiving a target HARQ-ACK bit block;
wherein a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

9. The second node according to claim 8, wherein in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

10. The second node according to claim 8, wherein a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell;
or, wherein a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

11. The second node according to claim 8, wherein if at least one HARQ-ACK bit corresponding to the target serving cell is generated for the target monitoring occasion in the process of determining the target HARQ-ACK bit block, the target HARQ-ACK bit block comprises the at least one HARQ-ACK bit corresponding to the target serving cell for the target monitoring occasion.

12. The second node according to claim 9, wherein an IE BWP-Downlink used to configure the same active BWP comprises a first parameter set, within the same active BWP, each parameter in the first parameter set is adopted both before and after the first-type configuration change occurs; or, an IE BWP-Uplink used to configure the same active BWP comprises a first parameter set, within the same active BWP, each parameter in the first parameter set is adopted both before and after the first-type configuration change occurs.

13. The second node according to claim 8, wherein multiple frequency-band resources are configured for the same active BWP, and the first-type configuration change comprises switching among the multiple frequency-band resources within the same active BWP.

14. A method in a first node for wireless communications, comprising:
monitoring a PDCCH at least associated with a target serving cell in a target monitoring occasion, the target serving cell being a configured serving cell; and
transmitting a target HARQ-ACK bit block;
wherein a first-type configuration change comprises a change in frequency-band resources, and the first-type configuration change occurs within a same active BWP; a reference change occasion comprises time occupied by the first-type configuration change, and the target HARQ-ACK bit block depends on a sequence between the target monitoring occasion and the reference change occasion.

15. The method in a first node according to claim 14, wherein in the process of determining the target HARQ-ACK bit block: for the target monitoring occasion, whether to skip a generation of HARQ-ACK bit(s) corresponding to the target serving cell depends on the sequence between the target monitoring occasion and the reference change occasion.

16. The method in a first node according to claim 14, wherein a first condition set comprises that the target monitoring occasion is before the reference change occasion; in the process of determining the target HARQ-ACK bit block: for the target monitoring occasion, if each condition in the first condition set is satisfied, skipping a generation of HARQ-ACK bit(s) corresponding to the target serving cell.

17. The method in a first node according to claim 14, wherein a first condition set comprises that the target monitoring occasion is before the reference change occasion, and a second condition set comprises at least one condition related to the target monitoring occasion; in the process of determining the target HARQ-ACK bit block: for the target monitoring occasion: if each condition in the first condition set is satisfied or any condition in the second condition set is satisfied, skipping a generation of HARQ-ACK bit(s) corresponding to the target serving cell, otherwise generating at least one HARQ-ACK bit corresponding to the target serving cell.

18. The method in a first node according to claim 14, wherein if at least one HARQ-ACK bit corresponding to the target serving cell is generated for the target monitoring occasion in the process of determining the target HARQ-ACK bit block, the target HARQ-ACK bit block comprises the at least one HARQ-ACK bit corresponding to the target serving cell for the target monitoring occasion.

19. The method in a first node according to claim 15, wherein an IE BWP-Downlink used to configure the same active BWP comprises a first parameter set, within the same active BWP, each parameter in the first parameter set is adopted both before and after the first-type configuration change occurs; or, an IE BWP-Uplink used to configure the same active BWP comprises a first parameter set, within the same active BWP, each parameter in the first parameter set is adopted both before and after the first-type configuration change occurs.

20. The method in a first node according to claim 14, wherein multiple frequency-band resources are configured for the same active BWP, and the first-type configuration change comprises switching among the multiple frequency-band resources within the same active BWP.
